(19) United States
(12) Patent Application Publication
(10) Pub. No.: US 2026/0252830 A1
(43) Pub. Date: Aug. 27, 2026

(54) DYNAMIC INVENTORY RESPONSE THRESHOLDING

(71) Applicant: QUALCOMM Incorporated, San Diego, CA (US)

(72) Inventors: Qi FU, San Diego, CA (US); Bhupesh Manoharlal UMATT, San Diego, CA (US); Kiran PATIL, San Diego, CA (US); Scott HOOVER, Del Mar, CA (US); Ajay Vignesh JAYAPRAKASH, San Diego, CA (US); Sheng-Yuan TU, San Diego, CA (US); Chetan Jagdeesh BHARADWAJ, Erie, CO (US); Sayak SAHA, San Diego, CA (US)

(21) Appl. No.: 19/065,992

(22) Filed: Feb. 27, 2025

(51) Int. Cl. G06K 7/10

(52) U.S. Cl. CPC G06K 7/10297

(57) ABSTRACT

Systems and techniques are described herein for wireless communication. For example, a computing device can transmit, by a short range device (SRD), a first signal to one or more tags. The computing device can determine tag response statistics associated with a response time of the one or more tags to the first signal. The computing device can adjust, based on the tag response statistics, a first time threshold associated with a wait time of the SRD for additional responses from the one or more tags for inventorying the one or more tags.

### FIELD

The present disclosure generally relates to wireless communication using short range wireless communications (e.g., radio frequency a Radio Frequency identification (RFID) or other short range wireless communications). For example, aspects of the present disclosure relate to systems and techniques for dynamic tag inventory response thresholding (e.g., time thresholding).

### BACKGROUND

Wireless communication technologies are generally classified based on range. For example, wireless communication technologies can be classified as short range wireless communication technologies and long range wireless communication technologies. Short range wireless communication technologies can enable wireless communication over relatively short distances (e.g., within thirty meters) and long range wireless communication can enable wireless communication over relatively long distances (e.g., more than thirty meters). Radio Frequency Identification (RFID) systems are generally classified as short range wireless communication. RFID technologies provide wireless transfer of data between a reader (e.g., RFID reader device) and a tag or transponder (e.g., RFID tag). RFID systems are generally used for identifying, inventorying, and tracking information associated with tagged physical objects (e.g., a box in a warehouse, items in a store, etc.).

For example, an RFID tag can be attached to an item to be tracked. RFID tags generally include data storage and an antenna. The data storage stores information corresponding to the associated item. The antenna can allow information from the RFID tag, or the RFID tag, to be read by an RFID reader, which transmits an interrogating signal to one or more RFID tags within communication range. RFID tags can be powered by the RFID reader (e.g., powered by the interrogating signal from the RFID reader).

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In some aspects, an apparatus for wireless communications is provided. The apparatus includes at least one memory and at least one processor coupled to the at least one memory and configured to: transmit, by a short range device (SRD), a first signal to one or more tags; determine tag response statistics associated with a response time of the one or more tags to the first signal; and adjust, based on the tag response statistics, a first time threshold associated with a wait time of the SRD for additional responses from the one or more tags for inventorying the one or more tags.

In some aspects, a method for wireless communications is provided. The method includes: transmitting, by a short range device (SRD), a first signal to one or more tags; determining tag response statistics associated with a response time of the one or more tags to the first signal; and adjusting, based on the tag response statistics, a first time threshold associated with a wait time of the SRD for additional responses from the one or more tags for inventorying the one or more tags.

In some aspects, a non-transitory computer-readable medium is provided having stored thereon instructions that, when executed by at least one processor, cause the at least one processor to: transmit, by a short range device (SRD), a first signal to one or more tags; determine tag response statistics associated with a response time of the one or more tags to the first signal; and adjust, based on the tag response statistics, a first time threshold associated with a wait time of the SRD for additional responses from the one or more tags for inventorying the one or more tags.

In some aspects, an apparatus for wireless communication is provided. The apparatus includes means for transmitting a first signal to one or more tags; means for determining tag response statistics associated with a response time of the one or more tags to the first signal; and means for adjusting, based on the tag response statistics, a first time threshold associated with a wait time of a SRD for additional responses from the one or more tags for inventorying the one or more tags.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a block diagram illustrating an example of a wireless communication network, in accordance with aspects of the present disclosure.

FIG. 2A is a diagram illustrating example components of a device, in accordance with aspects of the present disclosure.

FIG. 2B is a diagram illustrating an example of a radio frequency (RF) energy harvesting device, in accordance with aspects of the disclosure.

FIG. 3 is a diagram illustrating an example of a radio frequency identification (RFID) system as an example of a short range wireless communication system, in accordance with aspects of the present disclosure.

FIG. 4A is a block diagram illustrating an example inventorying process over a period of time, in accordance with aspects of the present disclosure.

FIG. 4B is a diagram illustrating an example of a process for passive devices (e.g., tags, such as RFID tags) to reply to a query signal for inventory based on their slot counter numbers, in accordance with some aspects of the disclosure.

FIG. 5 is a block diagram illustrating an example inventorying process with dynamic time thresholds over a period of time, in accordance with aspects of the present disclosure.

FIG. 6 is a flowchart diagram illustrating an example of a process for adjusting a first time threshold of an inventorying process, in accordance with aspects of the present disclosure.

FIG. 7 is a flowchart diagram illustrating an example of a process for adjusting a second time threshold of an inventorying process, in accordance with aspects of the present disclosure.

FIG. 8 is a flowchart diagram illustrating an example of a process for wireless communications, in accordance with aspects of the present disclosure.

FIG. 9 is a block diagram illustrating example computing device architecture of an example computing device which can implement the various techniques described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the example embodiments will provide those skilled in the art with an enabling description for implementing an example embodiment. It should be understood that various changes may be made in the function and arrangement of elements without departing from the spirit and scope of the application as set forth in the appended claims.

Wireless communication networks can be deployed to provide various communication services, such as voice, video, packet data, messaging, broadcast, any combination thereof, or other communication services. A wireless communication network may support both access links and sidelinks for communication between wireless devices. Wireless communication technologies are generally classified based on range. For example, wireless communication technologies can be classified as short range wireless communication technologies and long range wireless communication technologies. Short range wireless communication technologies can enable wireless communication over relatively short distances (e.g., within thirty meters) and long range wireless communication can enable wireless communication over relatively long distances (e.g., more than thirty meters).

In various wireless communication networks, client devices can be utilized that may be associated with different signaling and communication needs. For example, long range wireless communication can be achieved using telecommunications networks, such as 5G networks. As telecommunications networks expand into industrial verticals and the quantity of deployed Internet-of-Things (IoT) devices grows, network service categories such as enhanced Mobile Broadband (eMBB), Ultra Reliable Low Latency Communications (URLLC), and massive Machine Type Communications (mMTC), etc., may be expanded to better support various IoT devices, which can include passive IoT devices, semi-passive IoT devices, etc. In some aspects, passive IoT devices may also be referred to as “ambient IoT devices” or simply as “passive devices”. For example, an ambient IoT device may be an IoT device that can perform ambient energy harvesting. An ambient IoT device may also be referred to as an ambient energy harvesting device. As used herein, the term “ambient IoT devices” may refer to active IoT devices, passive IoT devices, and/or semi-passive IoT devices.

In some examples, ambient IoT devices (e.g., active IoT devices, passive IoT devices, semi-passive IoT devices, etc.) are relatively low-cost devices that may be used to implement one or more sensing and communication capabilities in an IoT network or deployment. In some examples, passive and/or semi-passive IoT sensors (e.g., devices) can be used to provide sensing capabilities for various processes and use cases, such as asset management, logistics, warehousing, manufacturing, etc. (e.g., to monitor, track, and locate items associated with the passive IoT devices). Passive and semi-passive IoT devices can include one or more sensors, a processor or micro-controller, and an energy harvester for generating electrical power from incident downlink radio frequency (RF) signals received at the passive or semi-passive IoT device. Energy harvesting devices can be deployed at large scales, based on the simplification in their manufacture and deployment associated with implementing wireless energy harvesting.

Currently, passive devices, such as in the form of electronic tags (e.g., Radio Frequency Identification (RFID) tags or tags operating using another form of short range communications), are a rapidly growing technology impacting many industries, due to their economic potential for inventory and/or asset management inside and outside warehouses, IoT devices, sustainable sensor networks in factories and/or agriculture, and smart home usage. Electronic tags may include small transponders, or tags, that emit an information-bearing signal after receiving a signal.

Energy harvesting devices (e.g., electronic tags such as RFID tags) can harvest energy over-the-air to power their transmission and reception circuitry. For example, in some cases, energy harvesting devices can harvest energy from ambient downlink RF signals (e.g., including dedicated downlink RF signals for energy harvesting and various other downlink RF signals that are not dedicated energy harvesting signals). Based on harvesting energy from incident downlink radio frequency (RF) signals (e.g., transmitted by a network device, such as a reader device or an interrogator), ambient energy harvesting devices (e.g., passive IoT devices, which may be in the form of electronic tags such as RFID tags) may be provided without an energy storage element and/or can be provided with a relatively small energy storage element (e.g., battery, capacitor, etc.). For example, energy harvesting devices (e.g., electronic tags) can operate without a battery at a low operating expense (OPEX), with a low maintenance cost, and with a long-life cycle. Ambient energy harvesting devices provided without an energy storage element may include passive IoT devices. Ambient energy harvesting devices provided with a relatively small energy storage element may include semi-passive IoT devices. Ambient energy harvesting devices that are provided with an energy storage element may include active IoT devices. Energy harvesting devices can be deployed at large scales, based on the simplification in their manufacture and deployment associated with implementing wireless energy harvesting.

In a wireless communication environment, a device (e.g., such as a reader device or interrogator) can be used to transmit downlink RF signals to energy harvesting devices. In one illustrative example, a reader device can read and/or write information stored on energy harvesting IoT devices (e.g., electronic tags, which may each be associated with a respective item) by transmitting the downlink RF signal. The downlink RF signal can provide energy to an energy harvesting IoT device. The energy harvesting IoT device can transmit (e.g., based on reflecting or backscattering a portion of the incident downlink RF signal) a response signal (e.g., an information-bearing uplink signal) back to the reader device, after the energy harvesting IoT device is sufficiently energized based on the downlink RF signal. The reader device can read the signal transmitted by an energy harvesting IoT device to decode the information transmitted by the IoT device (e.g., such as sensor information collected by one or more sensors included in the IoT device, etc.).

In some cases, an energy harvesting device can use the same antenna for energy harvesting and communications. For example, an energy harvesting device can use the same antenna to perform energy harvesting and backscatter communications, where the energy harvesting and the backscatter communications are based on the same downlink RF signal. In some examples, an energy harvesting device can include a first antenna used for energy harvesting and a second antenna used for communications, where the first antenna is different from the second antenna. For instance, an ambient IoT device can use the first antenna to perform energy harvesting and can use the second antenna to perform communication (e.g., transmitting and/or receiving).

A backscatter transmitter of an energy harvesting device can generate and transmit an uplink signal (also referred to as a backscatter signal) by reflecting and backscatter modulating an incident downlink signal using the first antenna. In some examples, an ambient IoT device can use a backscatter transmitter that is the same as or similar to a backscatter transmitter utilized by a passive or semi-passive IoT device, as described above. An active transmitter can use a battery or other energy storage element included in the ambient IoT device to generate and transmit an uplink signal, using an antenna that is different from the first antenna associated with the backscatter transmitter (e.g., a second antenna). To transmit an uplink signal, the backscatter transmitter of an ambient IoT device must first receive a downlink signal that can be reflected and backscatter modulated. For example, the backscatter transmitter may be unable to transmit an uplink signal unless or until a continuous sine wave is received as a downlink signal from a reader device or other energy source network device. The active transmitter of an ambient IoT device can perform uplink communication that is triggered by the ambient IoT device (e.g., without dependence on first receiving a downlink signal). In some examples, ambient IoT devices may include a small battery or energy storage element and may be unable to sustain longer periods of uplink communication using the active transmitter of the ambient IoT device. For example, active transmission by an ambient IoT device may quickly deplete the onboard battery or other energy storage element(s) included in the ambient IoT device.

In some examples, for a given downlink signal with a given input RF power received at an ambient energy harvesting device, a first portion of the input RF power is provided to the device's energy harvester (e.g., with a percentage being converted to useful electrical power based on the conversion efficiency of the harvester, and the remaining percentage wasted or dissipated as heat, etc.). A remaining, second portion of the input RF power is available for use in the backscattered uplink transmission (e.g., the second portion of the input power is reflected and modulated with the uplink communication).

An energy harvesting tag (EH-tag) system is an ambient IoT system. The system generally includes an energizer (e.g., a reader device or interrogator) and an electronic tag (e.g., which is a low cost device). An electronic tag does not include a battery and relies on wireless power transfer (WPT) from over-the-air to perform energy harvesting (e.g., to harvest energy from the wireless signals transmitted from the energizer). The energizer can send a downlink wireless power transfer waveform (e.g., including a continuous waveform (CW)) to the electronic tags.

An example of an energy harvesting device (e.g., tag) is an RFID tag configured to communicate using RFID communications. RFID systems are generally classified as short range wireless communication. RFID technologies provide wireless transfer of data between a reader (e.g., RFID reader device) and a tag or transponder (e.g., RFID tag). RFID systems are generally used for identifying, inventorying, and tracking information associated with tagged physical objects (e.g., a box in a warehouse, items in a store, etc.).

While examples described herein use RFID systems for illustrative purposes, systems other than RFID systems can provide short range wireless communication according to aspects described herein. For example, other types of short range wireless communication systems can communicate using other types of short range communications, such as near field communication (NFC), Bluetooth™, Wi-Fi, SRD860, or other short range communication technology. Short range communications systems can include one or more short range devices (SRDs) and one or more passive devices (e.g., energy harvesting devices, tags, etc.). For example, an SRD can use energy (e.g., RF energy) emitted by itself, and/or by other sources, to excite or charge a receiver, such as a tag (e.g., an RFID tag or other type of tag, etc. An RFID reader device is an example of an SRD. Examples of passive devices (e.g., energy harvesting devices) of SRD systems include electronic tags or other devices. The one or more SRDs and/or passive devices can be configured to communicate using one or more short range communications protocols (e.g., NFC, Bluetooth™, Wi-Fi, SRD860, etc.).

In some cases, a tag (e.g., an RFID tag or other type of short range communication tag) can be attached to an item to be tracked. For example, RFID tags generally include data storage and an antenna. The data storage stores information corresponding to the associated item. The antenna can allow information from the RFID tag, or the RFID tag, to be read by an RFID reader, which transmits an interrogating signal to one or more RFID tags within communication range. RFID tags can be powered by the RFID reader (e.g., powered by the interrogating signal from the RFID reader).

RFID systems can be used for wireless communication between a reader device (e.g., RFID reader) and one or more tags or transponders (e.g., RFID tags). An RFID reader may also be referred to as an “RFID interrogator,” and “RFID scanner,” and/or an “energizer.” RFID systems can be used to identify and/or track various items that are associated with one or more RFID tags (e.g., various items to which one or more RFID tags are attached). RFID systems can read and/or write information to and/or from (respectively) RFID tags, based on respective wireless communications between an RFID reader and the RFID tags.

For example, an RFID reader (e.g., energizer) can be used to interrogate one or more RFID tags to obtain information of the nearby items that are within communication range of the RFID reader and the interrogation signal. The RFID reader (e.g., energizer) can transmit an RF signal to perform the energizing and interrogating of the RFID tags. An RFID tag that receives the interrogating RF wave can respond by backscattering (e.g., reflecting back) and/or transmitting another RF wave, as previously described. An RFID tag may generate the responsive RF wave originally (e.g., in examples where the RFID tag is an active or semi-active tag). An RFID tag may generate the responsive RF wave passively, for instance by reflecting back a portion of the interrogating RFID wave using a backscatter process (e.g., in examples where the RFID tag is a passive tag). The responsive RF wave can be referred to as the immediate RFID tag reply. The timing of the responsive RF wave can be tracked by the RFID reader during inventorying. For example, the RFID reader can include a threshold time for when the RFID reader anticipates the responsive RF wave. In one example, the threshold time can represent a time from interrogator (e.g., the RFID reader) transmission to the RFID tag (e.g., T1 of the Electronic Product Code (EPC) Generation 2 (e.g., Gen2) standards). T1 can represent a threshold time period or range of time during which the RFID anticipates a response (e.g., the responsive RFID wave) from the RFID tag. In one example, when the RFID reader does not receive a response from the RFID reader (e.g., the responsive RFID wave) within the T1 time period, the RFID reader proceed with transmitting inventorying commands in the inventorying process such as transmitting a query command for subsequent RFID tags, performing duplicative actions such as retransmitting a message to the RFID tag, terminating the inventorying process, etc. In another example, when no reply is within the T1 time period, the RFID reader can determine there was no reply from tags. In such an example, the RFID reader can determine to transmit a next inventory command such as a QueryRep, QueryAdjust, or Query, or detect end of inventory (Q=0 and no tag reply).

An RFID tag attached to a respective item, or attached to a group of items, can store corresponding information thereof. For example, an RFID tag can include a data storage element that stores information corresponding to the item(s) to which the RFID is attached and associated. For instance, RFID tag information can include one or more of a product name, a serial number, product information, a manufacturer, etc. In some examples, the RFID tag can store identification information that is directly indicative of a tagged item, product, object, etc. For instance, an RFID tag can store identification information such as a unique product serial number, etc. In some examples, the RFID tag does not store product or item identification information directly, and stores a unique RFID tag serial number or identification number which may be externally mapped to various item identification information such as product serial numbers, product names, product SKUs, etc.

An RFID reader (e.g., energizer) can transmit an RF signal configured to cause the RFID tags to transmit at least a portion of their respective identification information. The RFID reader can receive (e.g., scan) the identification information transmitted by the one or more RFID tags energized by the RFID reader and can use the identification information to track inventory of tagged items or products that are within range of the RF signal of the RFID reader (e.g., nearby such as within 30 meters). The timing of responses can be tracked by the RFID reader during inventorying. For example, the RFID reader can include a threshold time for when the RFID reader anticipates a response from the RFID tags. In some examples, the response can be a separate response from the responsive RF signal. The threshold time can represent a time from RFID tag response interrogator (e.g., the RFID reader) transmission of a subsequent command or RFID reader response to the RFID tag (e.g., T2 of the EPC Gen2 standards).

RFID readers can be configured to read hundreds of RFID tags per second, based on the respective RFID tags responding to an interrogation signal from the RFID reader using a corresponding time slot determined for the respective RFID tag. For example, the RFID tags can generate (or select) a random number based on a Q-value initially sent by the RFID reader using a Query command, or implicitly decremented or incremented by QueryAdjust command. The Q-value can represent a parameter used by an RFID reader to predict a number of RFID tags to communicate with by being used to set a number of slots for ordering response order of RFID tags. For example, the RFID tag can generate a random number in the range of 0 to 2^{Q}−1 based on the Q-value. In such an example, RFID tags may decrement a slot counter of the RFID tag (e.g., the slot counter indicating when the RFID tag responds in order) when the RFID tag receives a QueryRep command. In such an example, RFID tags with a slot counter value of 0 can respond to the RFID reader.

For example, RFID tags can respond to an interrogation signal based on randomly choosing a time slot within a configured time window for response. In some cases, an anti-collision algorithm can be used to divide a time window into a plurality of discrete time slots for RFID tags responses, within which each RFID tag can randomly choose or be assigned a particular time slot. In further examples, the anti-collision algorithm can be used to determine an optimized Q-value during inventorying to increase probability RFID tags are decoded instead of a no reply or a collision. Each RFID tag transmits its identification information back to the reader in the corresponding or allocated time slot for the RFID tag. Restricting each RFID tag to a particular time slot reduces the chances of a collision occurring when two or more RFID tags attempt to transmit during the same time slot. When a collision occurs, the multiple RFID tags attempting to transmit during the same time slot are not successfully read by the RFID reader and may be configured to select new time slots and retransmit. In another example, of when a collision is detected (e.g., multiple tags replied at a predetermine time period or slot), at most one RFID tag can be decoded and the other RFID tags which replied at the same time period or slot are not resolved. The unresolved RFID tags can return to inventorying when a Query Adjust or Query command is received by the unresolved RFID tags. When the RFID reader continues with a QueryRep command, the unresolved RFID tags can have slot counters underflowed (e.g., adjust to become a value such as 7FFF).

RFID protocol time durations (e.g., thresholds) in inventorying are generally classified into two different classes. For example, an initial message sequence including a Select(T)/Challenge(T) message to one or more RFID tags. In such an example, the sequence can be represented as a sequence of messages or commands from the perspective of the RFID reader. In such an example, T represents transmissions from the RFID reader to the RFID tags and R represents messages or commands received by the RFID reader. For example, the Select(T)/Challenge(T) represent messages or commands transmitted from the RFID reader to the RFID tags. In continuing the example, a sequence of messages representing back and forth communication between the RFID reader and the one or more RFID tags can be represented as Query(T) to RN16 (R) (e.g., random number 16 digit response from an RFID tag to the RFID reader). The sequence can continue with ACK(T) (e.g., an acknowledgement message or command from the RFID reader to the RFID tag confirming receipt of the RFID response which in this example is RN16(R)). The sequence can continue to with EPC (R) representing transmission of a tag identifier associated with an RFID tag. The RFID reader can store information associated with the tag identifier to indicate the RFID tag has been inventoried.

In another sequence, the messages can include QueryRep(T) (e.g., a command for decrementing a slot counter of the RFID tags from EPC Gen2 standards) to RN16(R) to ACK(T) to EPC (R). The aforementioned sequence can be used to read and inventory subsequent RFID tags. The timing of the sequences (e.g., how long the RFID reader and RFID tags wait for responses) can be defined by the aforementioned T1 and T2 of the EPC Gen2 standards.

Systems, apparatuses, electronic devices, methods (also referred to as processes), and computer-readable media (collectively referred to herein as “systems and techniques”) are described herein for wireless communication. For example, the systems and techniques are described herein for dynamic inventorying processes using short range wireless communication (e.g., inventorying processes with dynamic time thresholds of T1 and T2 in the inventorying process). In some aspects, the systems and techniques can include operations for improving efficiency in inventorying processes by reducing computing resources and reducing time for inventorying using dynamic (e.g., adjustable) time thresholds of T1 and T2 in the inventorying process.

Examples described herein use RFID systems for illustrative purposes. However, the systems and techniques can operate using systems other than RFID systems (e.g., including one or more SRDs and one or more tags) that can communicate using other types of short range wireless communications, such as near field communication (NFC), Bluetooth™, Wi-Fi, SRD860, or other short range communication technology.

In some aspects, the systems and techniques can include an SRD (e.g., an RFID reader or other SRD) and one or more tags (e.g., RFID tags or other types of tags). For example, an RFID reader can transmit signals (e.g., messages, commands, etc.) to the RFID tags and can receive signals from the RFID tags (e.g., an RFID tag response). For example, the RFID reader can transmit a query to one or more RFID tags (e.g. a query inventorying command QUERY of EPC Gen2). The systems and techniques can include using an adjustable T1 time threshold. The T1 time threshold can be adjustable based on RFID tag response statistics. For example, the T1 time threshold can be adjustable based on the amount of time for RFID tags to provide an immediate reply (e.g., the responsive RFID wave) to the RFID reader.

For example, the RFID reader can perform inventorying for a plurality of RFID tags. The systems and techniques can include adjusting the T1 time threshold based on the RFID tag response statistics. In such an example, the RFID tag response statistics can include information such as an average amount of time for the RFID tags to respond (e.g., with the responsive RF wave or signal). In further examples, RFID tag response statistics can include a lowest response time (e.g., shortest) of the one or more RFID tags and a highest response time (e.g., longest) of the one or more RFID tags (e.g., RFID tags can respond in shorter or longer periods of time). In some examples, the systems and techniques can include performing various probabilistic and statistical methods to collected response time information to generate a distribution of response times. For example, the systems and techniques can include determining standard deviations of response times. In such an example, the systems and techniques can include setting the T1 time threshold based on the standard deviation (e.g., based on a predetermined number of standard deviations associated with a desired accuracy of the system).

For example, in a standard normal distribution, three standard deviations can represent a system with 99.73% accuracy (e.g., only 0.27% of RFID tags respond slower than what would be identified in a system with three standard deviations of accuracy). In some examples, the T1 time threshold is adjustable during the inventorying process. In such an example, T1 can be set to a first time threshold value (e.g., 20 microseconds) and based on the response time of an RFID tag, the first time threshold value can be increased or decreased.

For example, T1 can be defined in the EPC GEN2 Standard as MAX(RTcal, 10 T pri)*(1−FrT)−2 us≤T1≤MAX(RTcal, 10 Tpri)*(1+FrT)+2 us. In such an example, T1 can be defined within the aforementioned range of values to cover within two standard deviations of a standard normal distribution of the amount of time for the RFID tags to respond to the RFID reader. The standard normal distribution used is a theoretical standard normal distribution and does not necessarily reflect the actual amount of time RFID tags take to respond to the RFID reader. During the inventorying process, recording the amount of time for responses of the RFID tags can allow adjustment of T1 to reduce no reply rates using the recorded amount of times for responses to adjust T1. For example, the recorded amount of time to respond can be used to determine a standard normal distribution or standard deviations based on the actual amount of time to respond to RFID readers. Furthermore, the recorded amount of time can be analyzed for various RFID reader, RFID tags, locations, manufacturers, vendors, etc. to provide insight into differences between RFID tags and RFID readers, which can be used to set initial T1 values.

In such an example, FrT is frequency tolerance over backscatter link frequencies (BLF), which is a deviation from the nominal backscatter link frequency at which an RFID system operates. This tolerance can allow RFID tags and RFID to communicate even when there are slight variations in their operating frequencies due to manufacturing differences or environmental factors. For example, environmental temperature can impact BLF deviation. FrT values can be set as specified in the EPC GEN2 Standards, such as a frequency deviation ranging from 22% to 4%, depending on RFID configuration of DR and TRcal (e.g., Table 6.9: Tag-to-Interrogator link frequencies in the EPC GEN2 specification).

In some aspects, the systems and techniques can adjust the T1 time threshold based on environmental conditions such as the temperature of an environment in which the RFID tags or RFID reader is located. In such an example, the RFID tags can have different frequency tolerances and BLF associated with changes in physical properties of the RFID tags from changes in operating temperatures. In such an example, the T1 time threshold can be adjusted based on the temperature of the RFID tags, the RFID reader, or the environment in which the RFID tags and RFID reader are located.

In some aspects, the systems and techniques can include using an adjustable T2 time threshold. T2 can be adjustable based on RFID reader response statistics. In such an example, the RFID reader response statistics can include information associated with when the RFID reader receives a response from RFID tag (e.g., a response such as an RN16 or EPC message) and the amount of time the RFID tag waits for a response from the RFID reader before entering an arbitrate state (or other state). For example, T2 represents a time from an RFID tag response to the RFID reader transmission of a subsequent signal (e.g., message or command). For example, the T2 time threshold can be adjustable based on the amount of time for RFID tags wait for a response from the RFID reader before entering an arbitrate state.

In some aspects, the systems and techniques can include adjusting the T2 time threshold based on the RFID reader response statistics such as an average amount of time for the RFID tags to respond (e.g., a response such as an RN16 or EPC message). In further examples, RFID reader response statistics can include a lowest response time of the RFID tags and a highest response time of the RFID tags. For example, the systems and techniques can include recording the amount of time from when the RFID reader receives RFID tag replies to the RFID reader can transmit out a subsequent command. In such an example, the systems and techniques can include recording the amount of time when the RFID reader receives RFID tag replies at a time greater than 20 Tₚᵣᵢ (e.g., the max of T2 in the specification, Tₚᵣᵢ also being defined as a backscatter-link pulse-repetition interval of the EPC GEN2 Standards).

In some aspects, the systems and techniques can include performing or applying various probabilistic and statistical methods to collected response time information to generate a distribution of response times. In some examples, the T2 time threshold is adjustable during the inventorying process based on collected data associated with response times of the RFID tags or the RFID reader. In such an example, T2 can be set to a first time threshold value. T2 can be adjusted (e.g., increased, decreased, or maintained) based on the response time of the one or more RFID tags. For example, the RFID reader can attempt to respond immediately to the RFID tags, however due to RFID processing time, computational load, etc., the RFID reader can take longer than the T2 time threshold, such as 20 Tpri, to respond to the RFID tags. For example, whether an RFID tag will be able to respond within 20 Tₚᵣᵢ to 32 Tₚᵣᵢ may be initially unknown. In such an example, the threshold period of time T2 may be initially set to 32 Tₚᵣᵢ and reduced based on recorded response times of RFID tags. Further, the recording the response times associated with RFID tags of various manufacturers and locations, and operating under various environmental conditions, an initial RFID tag response time can be determined to be used as an initial prediction of the T2 and used as a threshold.

Various aspects of the present disclosure will be described with respect to the figures.

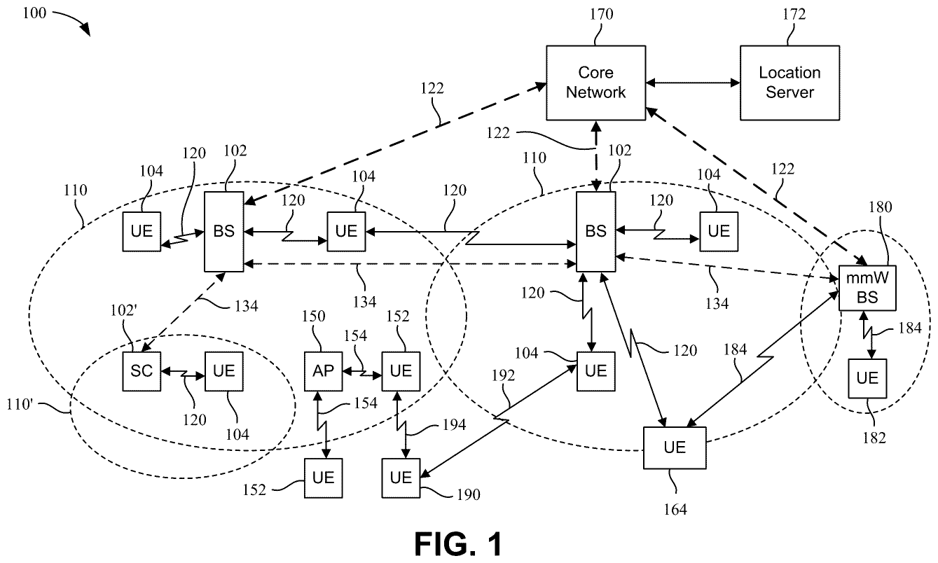

According to various aspects, FIG. 1 illustrates an example of a wireless communications system 100. The wireless communications system 100 (e.g., which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally, or alternatively, one or more of the base stations 102 can be implemented in a disaggregated base station architecture and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (e.g., high power cellular base stations) and/or small cell base stations (e.g., low power cellular base stations). In an aspect, the macro cell base station may include eNBs and/or ng-eNBs where the wireless communications system 100 corresponds to a long-term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (e.g., also referred to as reverse link) transmissions from a UE 104 to a base station 102 and/or downlink (e.g., also referred to as forward link) transmissions from a base station 102 to a UE 104. The communication links 120 may use MIMO antenna technology, including spatial multiplexing, beamforming, and/or transmit diversity. The communication links 120 may be provided using one or more carrier frequencies. Allocation of carriers may be asymmetric with respect to downlink and uplink (e.g., a greater or lesser quantity of carriers may be allocated for downlink than for uplink).

Beamforming, which may also be referred to as spatial filtering, directional transmission, or directional reception, is a signal processing technique that may be used at a transmitting device or a receiving device (e.g., one or more of the base stations 102, UEs 104, etc.) to shape or steer an antenna beam (e.g., a transmit beam, a receive beam) along a spatial path between the transmitting device and the receiving device. Beamforming may be implemented based on combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A transmitting device and/or a receiving device (e.g., such as one or more of base stations 102 and/or UEs 104) may use beam sweeping techniques as part of beam forming operations. For example, a base station 102 (e.g., or other transmitting device) may use multiple antennas or antenna arrays (e.g., antenna panels) to conduct beamforming operations for directional communications with a UE 104 (e.g., or another receiving device). Some signals (e.g., synchronization signals, reference signals, beam selection signals, or other control signals) may be transmitted by base station 102 (or other transmitting device) multiple times in different directions. For example, the base station 102 may transmit a signal according to different beamforming weight sets associated with different directions of transmission. Transmissions in different beam directions may be used to identify (e.g., by a transmitting device, such as a base station 102, or by a receiving device, such as a UE 104) a beam direction for later transmission or reception by the base station 102.

Some signals, such as data signals associated with a particular receiving device, may be transmitted by a base station 102 in a single beam direction (e.g., a direction associated with the receiving device, such as a UE 104). In some examples, the beam direction associated with transmissions along a single beam direction may be determined based on a signal that was transmitted in one or more beam directions. For example, a UE 104 may receive one or more of the signals transmitted by the base station 102 in different directions and may report to the base station 102 an indication of the signal that the UE 104 received with a highest signal quality or an otherwise acceptable signal quality.

In some examples, transmissions by a device (e.g., by a base station 102 or a UE 104) may be performed using multiple beam directions, and the device may use a combination of digital precoding or radio frequency beamforming to generate a combined beam for transmission (e.g., from a base station 102 to a UE 104, from a transmitting device to a receiving device, etc.). The UE 104 may report feedback that indicates precoding weights for one or more beam directions, and the feedback may correspond to a configured number of beams across a system bandwidth or one or more sub-bands. The base station 102 may transmit a reference signal (e.g., a cell-specific reference signal (CRS), a channel state information reference signal (CSI-RS), etc.), which may be precoded or unprecoded. The UE 104 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 102, a UE 104 may employ similar techniques for transmitting signals multiple times in different directions (e.g., for identifying a beam direction for subsequent transmission or reception by the UE 104) or for transmitting a signal in a single direction (e.g., for transmitting data to a receiving device).

A receiving device (e.g., a UE 104) may try multiple receive configurations (e.g., directional listening) when receiving various signals from the base station 102, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc., utilizing the ultra-wideband (UWB) spectrum. The UWB spectrum can range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (e.g., transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (e.g., from 450 to 6,000 Megahertz (MHz)), FR2 (e.g., from 24,250 to 52,600 MHz), FR3 (e.g., above 52,600 MHz), and FR4 (e.g., between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (e.g., whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (e.g., x component carriers) for transmission in each direction. The component carriers may or may not be adjacent to each other on the frequency spectrum. Allocation of carriers may be asymmetric with respect to the downlink and uplink (e.g., a greater or lesser quantity of carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (e.g., 40 MHz), compared to that attained by a single 20 MHz carrier.

In order to operate on multiple carrier frequencies, a base station 102 and/or a UE 104 can be equipped with multiple receivers and/or transmitters. For example, a UE 104 may have two receivers, “Receiver 1” and “Receiver 2,” where “Receiver 1” is a multi-band receiver that can be tuned to band (e.g., carrier frequency) ‘X’ or band ‘Y,’ and “Receiver 2” is a one-band receiver tunable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (e.g., an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (e.g., referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (e.g., through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

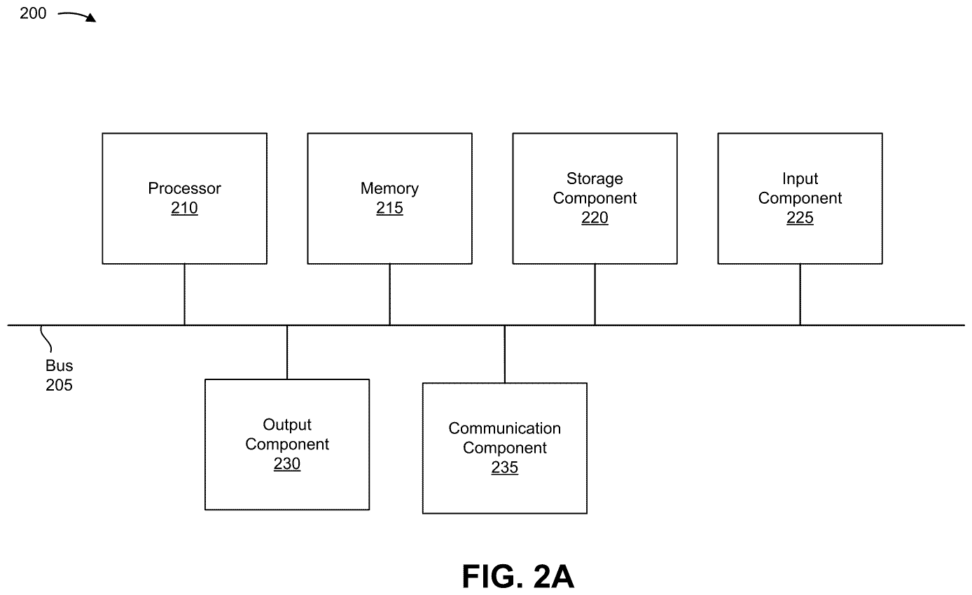

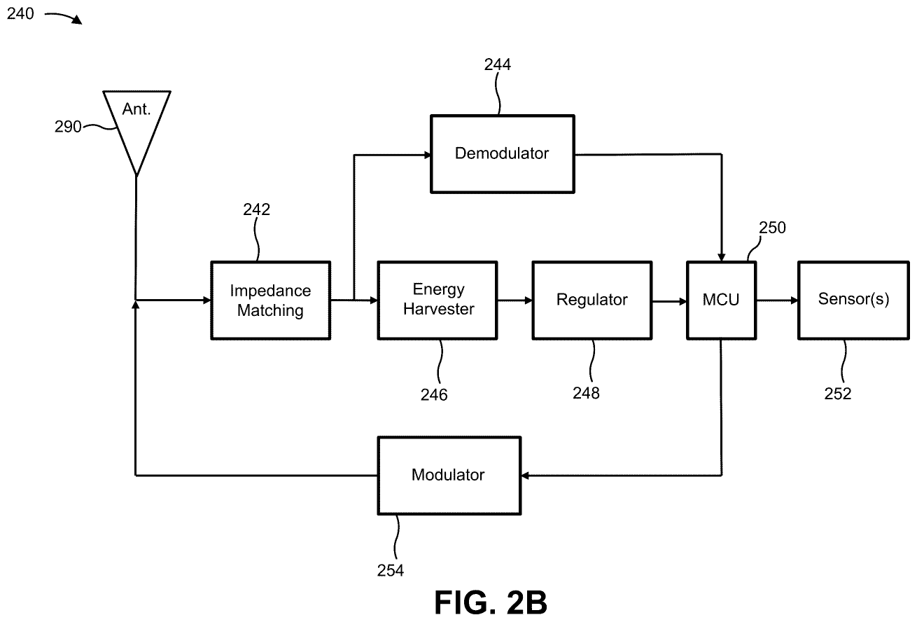

FIG. 2A is a diagram illustrating example components of a device 200, in accordance with the present disclosure. As shown in FIG. 2A, device 200 may include a bus 205, a processor 210, a memory 215, a storage component 220, an input component 225, an output component 230, and/or a communication component 235.

Bus 205 may include a component that permits communication among the components of device 200. Processor 210 may be implemented in hardware, firmware, or a combination of hardware and software. Processor 210 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, processor 210 may include one or more processors capable of being programmed to perform a function. Memory 215 may include a random access memory (RAM), a read only memory (ROM), and/or another type of dynamic or static storage device (e.g., a flash memory, a magnetic memory, and/or an optical memory) that stores information and/or instructions for use by processor 210.

Storage component 220 can store information and/or software related to the operation and use of device 200. For example, storage component 220 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 225 may include a component that permits device 200 to receive information, such as via user input (e.g., a touch screen display, a keyboard, a keypad, a mouse, a button, a switch, and/or a microphone). Additionally, or alternatively, input component 225 may include a component for determining a position or a location of device 200 (e.g., a global positioning system (GPS) component or a global navigation satellite system (GNSS) component) and/or a sensor for sensing information (e.g., an accelerometer, a gyroscope, an actuator, or another type of position or environment sensor). Output component 230 can include a component that provides output information from device 200 (e.g., a display, a speaker, a haptic feedback component, and/or an audio or visual indicator).

Communication component 235 may include one or more transceiver-like components (e.g., a transceiver and/or a separate receiver and transmitter) that enables device 200 to communicate with other devices, such as via a wired connection, a wireless connection, or a combination of wired and wireless connections. Communication component 235 may permit device 200 to receive information from another device and/or provide information to another device. For example, communication component 235 may include an Ethernet interface, an optical interface, a coaxial interface, an infrared interface, a radio frequency interface, a universal serial bus (USB) interface, a wireless local area interface (e.g., a Wi-Fi interface or a BLE interface), and/or a cellular network interface.

Communication component 235 may include one or more antennas for receiving wireless radio frequency (RF) signals transmitted from one or more other devices, cloud networks, and/or the like. The antenna may be a single antenna or an antenna array (e.g., antenna phased array) that can facilitate simultaneous transmit and receive functionality. The antenna may be an omnidirectional antenna such that signals can be received from and transmitted in all directions. The wireless signals may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network. In some cases, the antenna may be configured to emit continuous wave communications that can stimulate energy in an energy harvesting device (e.g., a RFID tag) such as energy harvesting device 240 shown in FIG. 2A. In some cases, the antenna may be configured to receive RFID communications from such an energy harvesting device.

The one or more transceiver-like components (e.g., a wireless transceiver) of the communication component 235 may include an RF front end including one or more components, such as an amplifier, a mixer (also referred to as a signal multiplier) for signal down conversion, a frequency synthesizer (also referred to as an oscillator) that provides signals to the mixer, a baseband filter, an analog-to-digital converter (ADC), one or more power amplifiers, among other components. The RF front-end can generally handle selection and conversion of the wireless signals into a baseband or intermediate frequency and can convert the RF signals to the digital domain.

In some cases, a CODEC may be implemented (e.g., by the processor 210) to encode and/or decode data transmitted and/or received using the one or more wireless transceivers. In some cases, encryption-decryption may be implemented (e.g., by the processor 210) to encrypt and/or decrypt data (e.g., according to the Advanced Encryption Standard (AES) and/or Data Encryption Standard (DES) standard) transmitted and/or received by the one or more wireless transceivers.

In some aspects, device 200 may represent an ESL. The ESL may include a battery in addition to the aforementioned components. In some aspects, the output component 230 of the ESL may be an electronic paper (e-paper) display or a liquid crystal display (LCD).

Device 200 may perform one or more processes described herein. Device 200 may perform these processes based on processor 210 executing software instructions stored by a non-transitory computer-readable medium, such as memory 215 and/or storage component 220. A computer-readable medium is defined herein as a non-transitory memory device. A memory device includes memory space within a single physical storage device or memory space spread across multiple physical storage devices.

Software instructions may be read into memory 215 and/or storage component 220 from another computer-readable medium or from another device via communication component 235. When executed, software instructions stored in memory 215 and/or storage component 220 may cause processor 210 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

The number and arrangement of components shown in FIG. 2A are provided as an example. In practice, device 200 may include additional components, fewer components, different components, or differently arranged components than those shown in FIG. 2A. Additionally, or alternatively, a set of components (e.g., one or more components) of device 200 may perform one or more functions described as being performed by another set of components of device 200.

FIG. 2B is a diagram illustrating an example of an architecture of a radio frequency (RF) energy harvesting device 240, in accordance with some examples. As will be described in greater depth below, the RF energy harvesting device 240 can harvest RF energy from one or more RF signals received using one or more antennas 290. As used herein, the term “energy harvesting” may be used interchangeably with “power harvesting.” In some aspects, energy harvesting device 240 can be implemented as an Internet-of-Things (IoT) device, can be implemented as a sensor, etc., as will be described in greater depth below. In other examples, energy harvesting device 240 can be implemented as a Radio-Frequency Identification (RFID) tag or various other RFID devices.

The energy harvesting device 240 includes the one or more antennas 290 that can be used to transmit and receive one or more wireless signals. For example, energy harvesting device 240 can use antenna(s) 290 to receive one or more downlink signals and to transmit one or more uplink signals. An impedance matching component 242 can be used to match the impedance of antenna(s) 290 to the impedance of one or more (or all) of the receive components included in energy harvesting device 240. In some examples, the receive components of energy harvesting device 240 can include a demodulator 244 (e.g., for demodulating a received downlink signal), an energy harvester 246 (e.g., for harvesting RF energy from the received downlink signal), a regulator 248, a micro-controller unit (MCU) 250, a modulator 254 (e.g., for generating an uplink signal). In some cases, the receive components of energy harvesting device 240 may further include one or more sensors 252.

The downlink signals can be received from one or more transmitters. For example, energy harvesting device 240 may receive a downlink signal from a network node or network entity that is included in a same wireless network as the energy harvesting device 240. In some cases, the network entity can be a base station, gNB, etc., that communicates with the energy harvesting device 240 using a cellular communication network. For example, the cellular communication network can be implemented according to the 3G, 4G, 5G, 6G, and/or other cellular standard (e.g., including future standards such as 6G and beyond).

In some cases, energy harvesting device 240 can be implemented as a passive or semi-passive energy harvesting device (e.g., an ambient energy harvesting device), which can perform passive uplink communication by modulating and reflecting a downlink signal received via antenna(s) 290. For example, passive and semi-passive energy harvesting devices may be unable to generate and transmit an uplink signal without first receiving a downlink signal that can be modulated and reflected. In other examples, energy harvesting device 240 may be implemented as an active energy harvesting device, which utilizes a powered transceiver to perform active uplink communication. An active energy harvesting device is able to generate and transmit an uplink signal without first receiving a downlink signal (e.g., by using an on-device power source to energize its powered transceiver).

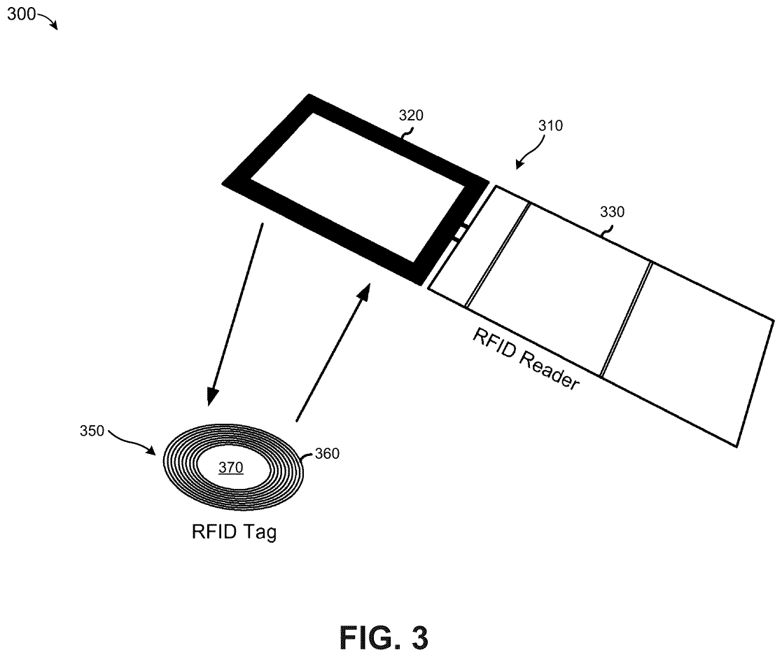

FIG. 3 is a diagram illustrating an example RFID system 300 that includes an RFID reader (e.g., energizer) 310 and an RFID tag 350. RFID reader 310 may also be referred to as an interrogator, a scanner, an energizer, etc. RFID tag 350 may also be referred to as an RFID label, an electronics label, etc. In some examples, the RFID reader 310 can be an SRD using various frequency bands to communicate with the RFID tag 350.

RFID reader 310 includes an antenna 320 and an electronics unit 330. Antenna 320 radiates signals transmitted by RFID reader 310 and receives signals from RFID tags (e.g., such as the RFID tag 350) and/or other devices. Electronics unit 330 may include a transmitter and a receiver for reading RFID tags such as RFID tag 350. The same pair of transmitter and receiver (or another pair of transmitter and receiver) may support bi-directional communication with wireless networks, wireless devices, etc. In some examples, a first RFID reader or RFID device can include a transmitter for energizing one or more RFID tags, and a second RFID reader or RFID device can include a receiver for receiving the reflected signals from the one or more RFID tags. For instance, an RFID reader can be configured to implement energizing and tag reading capabilities (e.g., includes a transmitter and a receiver), can be configured to implement energizing capabilities (e.g., includes a transmitter), and/or can be configured to implement tag reading capabilities (e.g., includes a receiver). The electronics unit 330 may include processing circuitry (e.g., a processor) to perform processing for data being transmitted and received by RFID reader 310.

RFID tag 350 includes an antenna 360 and a data storage element 370. Antenna 360 radiates signals transmitted by RFID tag 350 and receives signals from RFID reader 310 and/or other devices. For instance, RFID tags can be passive, active, or semi-active. Passive RFID tags utilize the interrogating signal from an RFID reader to power a transmission by or from the RFID tag. Active and semi-active RFID tags can include a power source or battery, which can be used to power a transmission by or from the RFID tag. In some examples, the RFID tag 350 may be a passive RFID tag having no battery. In this case, a magnetic field from a signal transmitted by RFID reader 310 (e.g., an energizing or interrogating signal from the RFID reader 310) may induce an electrical current in RFID tag 350, which may then operate based on the induced current. RFID tag 350 can radiate its signal in response to receiving a signal from RFID reader 310 or some other device.

The RFID tag 350 can use the data storage element 370 to store identification information corresponding to the RFID tag 350 and/or corresponding to an item associated with the RFID tag 350 (e.g., an item to which the RFID tag 350 is attached, etc.). For example, data storage element 370 can be used to store identification information using various granularity levels for tracking and management of an RFID tagged item. An RFID tag attached to a respective item, or attached to a group of items, may store corresponding information thereof. For example, the RFID tag 350 can be configured to store, using data storage element 370, identification information corresponding to the item(s) to which the RFID tag 350 is attached and associated. For instance, RFID tag information can include one or more of a product name, a serial number, product information, a manufacturer, etc. In some examples, the RFID tag 350 can store (e.g., using the data storage element 370) identification information that is directly indicative of a tagged item, product, object, etc. For instance, the RFID tag 350 can store identification information such as a unique product serial number, etc. In some examples, the RFID tag 350 does not store product or item identification information directly, and stores a unique RFID tag serial number or identification number corresponding to the RFID tag 350, which may be externally mapped to various item identification information such as product serial numbers, product names, product SKUs, etc.

Data storage element 370 can be configured to store identification information for RFID tag 350, e.g., in an electrically erasable programmable read-only memory (EEPROM). RFID tag 350 may also include an electronics unit that can process the received signal and generate the signals to be transmitted.

RFID tag 350 may be read as follows. RFID reader 310 may be placed or moved within close proximity to RFID tag 350. RFID reader 310 may radiate a first signal (which is also called an interrogation signal) via its antenna 320. The energy of the first signal may be coupled from RFID reader antenna 320 to RFID tag antenna 360 via magnetic coupling and/or other phenomena. RFID tag 350 may receive the first signal from RFID reader 310 via antenna 360 and, in response, may radiate a second signal (which is also referred to as a responding signal) comprising the information stored in data storage element 370. RFID reader 310 may receive the second signal from RFID tag 350 via antenna 320 and may process the received signal to obtain the information sent in the second signal.

RFID system 300 may be designed to operate at various frequencies and/or frequency ranges. For example, RFID system 300 can operate at 900 MHz, within a range of 860-960 MHz, etc., among various other example frequencies and/or frequency ranges of RFID operations. RFID reader 310 may have a specified maximum transmit power level, which may be imposed by the Federal Communication Commission (FCC) in the United Stated or other regulatory bodies in other countries.

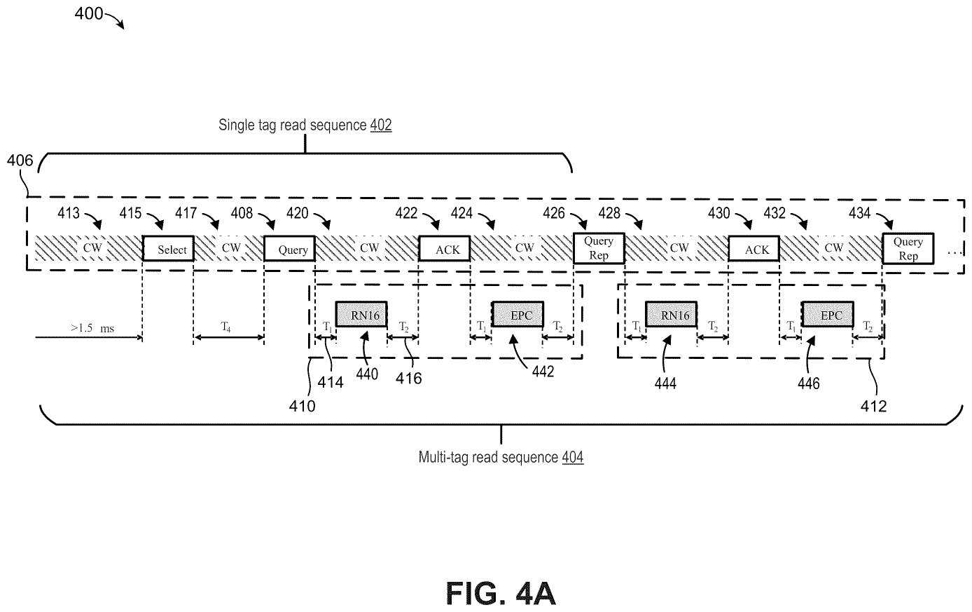

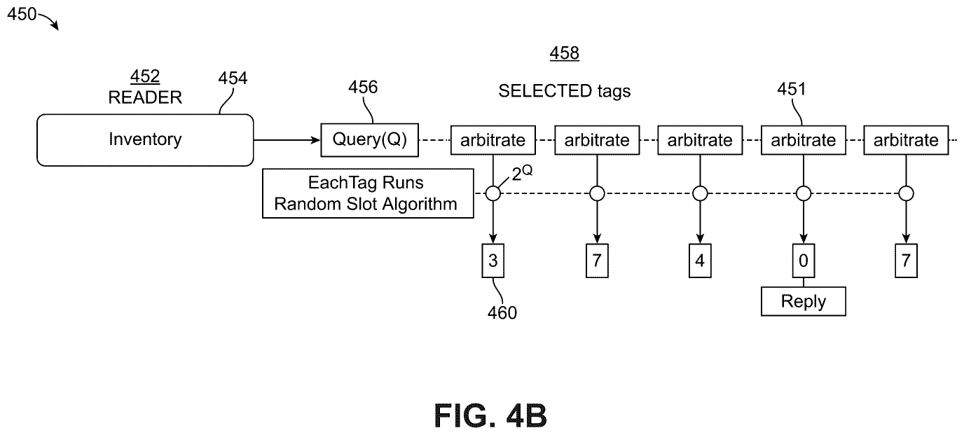

FIG. 4A is a block diagram 400 illustrating an example inventorying process over a period of time for a single tag sequence 402 and a multi-tag sequence 404. The block diagram 400 illustrates an example of illustrates a reader device (e.g., an RFID reader 406) in communication with a plurality of RFID tags (e.g., a first RFID tag 410 and a second RFID tag 412). In some examples, the RFID reader 406 can be an SRD in communication with the plurality of RFID tags using various frequency bands. As shown, one or more RFID tags (e.g., RFID tag 410, RFID tag 412, etc.) may be inventoried n sequence. The block diagram 400 includes an example of a single tag sequence 402 and an example of a multi-tag sequence 404. As depicted, the single tag sequence 402 and the multi-tag sequence 404 both include a sequence of various transmissions and receptions. Sequences 402 and 404 are exemplary and, as such, multiple different variations are possible. The sequence 402 and the sequence 404 each include various continuous wave segments, during which a continuous wave is emitted via an antenna on a device (e.g., a reader device). The sequence 402 and the sequence 404 each also include various receive segments, during which the device (e.g., the RFID reader 406) can listen for transmissions from the one or more RFID tags. The CW energizes any tags located within communications range of the device (e.g., the reader device), or if the tags are already energized, maintains the tags energized before the tags are read. For example, the RFID tags can be energized after being inventoried when receiving the continuous wave from the RFID reader.

The single tag sequence includes continuous wave (CW) 413, select 415, CW 417, query 408, CW 420 (and RN16 message 444), Acknowledgement (ACK) 422, and CW 424 (and EPC message 442). In the single tag sequence, a reader device can use the sequence Query(T)->RN16 (R)->ACK(T)->EPC (R) to read one tag, where “T” refers to the reader device transmitting and “R” refers to the reader device receiving (e.g., where the tag is transmitting). For instance, the reader device can first transmit a continuous wave (CW) 413. In the example depicted, the transmission time may be 1.5 milliseconds (ms), but other durations are also possible. In some examples, the RFID tags can receive commands 1500 microseconds after power-up.

Continuing the example, the reader device can then transmit a Select(T)/Challenge(T) message 415 to one or more of the tags. The reader device can then transmit a second CW 417 (which may be the same CW as the CW 413) for a time T4. In response, a tag can emit the RN16 message 440, T1 time after a start of the transmission of the CW 420. During this time, the reader device can continue to emit the CW 420. The reader device can respond with an ACK message 422 to avoid tag from going into an arbitrate state. In response, the tag can emit an EPC message 442, while the reader device continues to emit the CW 424. The EPC message 442 can be emitted T1 time after the start of the transmission of the CW 424.

The Electronic Product Code (EPC) Radio-Frequency Identity Generation-2 Ultra High Frequency (UHF) RFID standard (e.g., an RFID specification) provides for a potentially short turnaround time for timers T1 and T2. This short turnaround time requires a need for substantial computational resources, in addition to at least one antenna for an RFID application. In some cases, meeting additional requirements may be required. Such requirements may include frequency-hopping spread spectrum (FHSS) signaling for UL signals in the United States (US), and a need to meet anti-jammer requirements in the European Union (EU).

The multi-tag sequence 404 includes the operations of single tag sequence, followed by one or more repetitions of parts of the single tag sequence 402, such as Query repeat (Rep) 426, CW 428, ACK 430, CW 432, Query Rep 434, RN16 message 444, and EPC message 446. More specifically, multi-tag sequence 404 includes messages QueryRep(T)->RN16 (R)->ACK(T)->EPC (R) to read subsequent tags, which follows the initial message sequence, with a particular pre-defined timing cadence. These messages may be repeated, once for each additional tag.

A duration of the sequences depends upon a particular configuration that the reader device selects for transmitting and receiving data transmissions. In an example, a typical duration of the single tag sequence is from 1.2 to 50 ms. By contrast, the multi-tag sequence 404 may range as follows:

$$\{ 1.2 - 50 \} + ( a no\_of \_tags read ) * \{ 0.5 - 41 \} ms$$

In some cases, at least 1.5 ms may be needed to power up tags before sending any commands.

In one or more aspects, GS1 EPC Class1 Gen2 specifies a procedure for a reader device to extract EPCs from signals from multiple passive RFID devices (e.g., RFID tags). A slot counter is employed for this procedure. FIG. 4B shows an example of this procedure. In particular, FIG. 4B is a diagram illustrating an example of a process 450 for passive RFID devices (e.g., selected tags 458) to reply to a query signal (e.g., query (Q) 456) for inventory based on their slot counter numbers 460.

During operation of the process 450 of FIG. 4B, a plurality of passive RFID devices (e.g., selected tags 458) are powered up and operating in a ready state. At the start of an inventory round (e.g., inventory 454), a reader device 452 (e.g., a mobile device, which may be in the form of a mobile phone) can send a query signal (e.g., query (Q) 456) to a plurality of passive RFID devices (e.g., selected tags 458). The query signal can include a Q parameter. After receiving the query signal, the passive RFID devices (e.g., selected tags 458) can transition from the ready state to an arbitrate state 451.

In response to receiving the query signal and the Q parameter, the passive RFID devices (e.g., selected tags 458) can each determine a respective slot counter number 460 based on a random slot algorithm. The random slot algorithm can generate a slot counter number 460 that is within the range of (0, (2^{Q})−1). Only a passive RFID device with a slot counter number 460 equal to zero (0) can transmit a response signal (e.g., a reply) in response to receiving the query signal. Passive RFID devices with a slot counter number 460 equal to zero can transition from the arbitrate state 451 to a reply state. The response signal can include a random number packet (e.g., RN 16 packet). At the end of each inventory round, for the passive RFID devices with slot counter numbers 460 not equal to zero, each of the slot counter numbers 460 will be decremented by one (1) once passive device(s) receive a next QueryRep cmd. Returning to FIG. 4A, in one example, the RFID reader 406 can generate a command such as query 408 to request a response from the first RFID tag 410. In such an example, the RFID reader 406 can transmit the query 408 to the plurality of RFID tags. The first RFID tag 410 can respond to the RFID reader 406 with an immediate RF reply (e.g., a responsive RF wave) within the time period (e.g., or before a first time threshold 414, also referred to as T1).

The period of time from the query 408 to when the RFID reader 406 receives a response can be represented by the first time threshold 414 (e.g., T1, also referred to as a first time period). T1 can be represented as MAX(RTcal, 10Tₚᵣᵢ)*(1−|FrT|)−2 us≤T₁≤MAX(RTcal, 10Tₚᵣᵢ)*(1+|FrT|)+2 us with MAX(RTcal, 10Tₚᵣᵢ) representing a receive-to-transmit turn-around time of the RFID reader 406 and RFID tags (e.g., the first RFID tag 410 and the second RFID tag 412) as defined in the EPC GEN2 standard. Tₚᵣᵢ represents a backscatter-link pulse-repetition interval of the RFID reader and RFID tags. RTcal is a symbol representing calibration of the RFID reader to an RFID tag. FrT represents a frequency tolerance for tag-to-reader backscatter link frequencies (BLF).

In some examples, the frequency tolerance can vary based on temperature. For example, the frequency tolerance can vary from 4% to 22% under various BLF range with nominal temperature (e.g., temperature of the RFID tags). Frequency tolerance can increase for some frequency tolerance ranges with increases in temperature.

FrT can represent a maximum amount BLF can deviate from its nominal value MAX(RTcal, 10Tₚᵣᵢ) at a specific temperature. FrT can be more than three σ (standard deviation) of BLF nominal value. For example, three standard deviations cover 99.73% of deviations, two σ (e.g., 2*σ) covers 95.45% of deviations, one-sided two o covers 97.725% of deviations. FrT can be set as a max deviation at three σ. With FrT at three σ, the initial T1 max threshold can be set at MAX(RTcal, 10 T pri)*(1+⅔ *FrT)+2 us. The T1 max threshold can be adjusted based on recorded response rates associated with responses by the RFID tags. In some examples, the recorded response rates can be associated with the RFID tags at an operating temperature of the RFID tags (e.g., the operating temperature of the RFID tags when the response rates were recorded). In some examples, T1 can be set at an initial value associated with the temperature which the RFID tags are operating (e.g., in some examples, RFID tags can be set at different initial T1 values based on temperature).

The first RFID tag 410 can respond to the RFID reader 406 within the first time threshold 414. For example, the first RFID tag 410 can respond with an RN16 message or other responsive RF signal. The RFID reader 406 can generate and transmit an acknowledgement (ACK) message in response to the message from the first RFID tag 410 (e.g., by repeating the RN16 back to the first RFID tag 410). The RFID reader 406 can respond within a second time threshold 416 (e.g., T2, also referred to as a second time period). T2 can represent a time threshold before which the RFID tag can transmit a response to the first RFID tag 410. In some examples, failure to transmit a response to the first RFID tag 410 before expiration of T2 can result in the first RFID tag 410 entering an arbitrate state (e.g., an arbitration state) of the inventorying process. In the multi-tag sequence 404, the RFID reader can transmit a QueryRep command and continue the inventorying process with the second RFID tag 412.

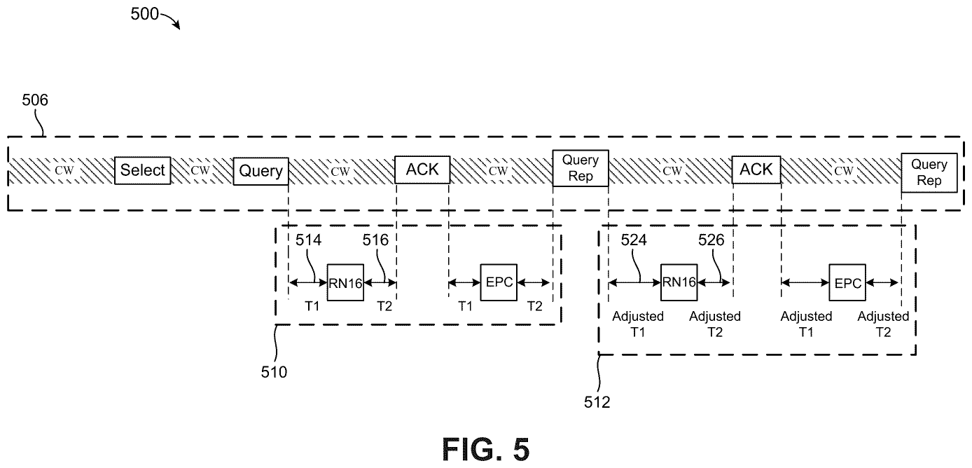

FIG. 5 is a block diagram 500 illustrating an example inventorying process with dynamic time thresholds over a period of time. For example, FIG. 5 includes an RFID reader 506 (or SRD), a first RFID tag 510, and a second RFID tag 512. The RFID reader 506 and the first RFID tag 510 can communicate using the first time threshold 514 and the second time threshold 516 as further described in the description of FIG. 4A. In FIG. 5, the RFID reader 506 can adjust the first time threshold 514 and the second time threshold 516 to an adjusted first time threshold 524 and an adjusted second time threshold 526 for subsequent responses from subsequent RFID tags (e.g., the second RFID tag 512).

In such an example, the RFID reader 506 can adjust the first time threshold 514 and the second time threshold 516 based on responses from RFID tags, such as the first RFID tag 510. In one example, the first time threshold can be initially set at T1=MAX (RTcal, 10 T pri)*(1+⅔ *FrT)+2 us and the second time threshold can be initially set at T2=32*Tₚᵣᵢ. In some examples, such as where the RFID reader 506 (or another RFID reader) has adjusted the first time threshold in a previous inventorying process, the first time threshold can be initially set to a time threshold used in the previous inventorying process. For example, the initial first threshold can be set based on past inventorying process of the RFID tags or other similar RFID tags (e.g., similar model, manufacturer, operating conditions, etc.).

For example, the RFID reader 506 can adjust the first time threshold 514 to the adjusted first time threshold 524 based on RFID tag response statistics associated with timing of the RFID tag responses to the RFID reader. In such an example, the RFID tag response statistics can include an average amount of time for the RFID tags to respond to a message from the RFID reader 506. In further examples, RFID tag response statistics can include a lowest response time of a one or more RFID tags and a highest response time of the one or more RFID tags. In another example, the systems and techniques can include performing various probabilistic and statistical methods to collected response time information (e.g., timing of responses) to generate a distribution of response times. For example, the systems and techniques can include generating a distribution of response times and determining standard deviations of response times in the distribution. In such an example, the systems and techniques can include setting the T1 time threshold based on a standard deviation (e.g., based on a predetermined number of standard deviations associated with a desired accuracy of the system) of the distribution. In one example, the RFID reader 506 (or component thereof) can collect various times of RFID tag replies. The various times can be represented as a distribution (e.g., a normal distribution). The RFID reader 506 (or component thereof) can determine an average and standard deviation of the timing. In such an example, the RFID reader 506 can set the first time threshold 524 to be the average time of reply within two standard deviations of the normal distribution.

The RFID reader 506 can adjust the second time threshold 516 based on RFID reader response statistics. In such an example, the RFID reader response statistics can include information associated with when the RFID reader 506 receives a response from an RFID tag (e.g., a response such as an RN16 or EPC message) and the amount of time the RFID tag waits for a response from the RFID reader 506 before entering an arbitrate state (or other state). For example, the second time threshold 516 represents a time from an RFID tag response to the RFID reader transmission of a subsequent signal (e.g., message or command). For example, the T2 time threshold (e.g., the second time threshold 516) can be adjustable based on the amount of time the RFID tags wait for a response from the RFID reader 506 before entering an arbitrate state.

In some examples, the RFID reader 506, or another device associated with the RFID reader 506, can generate a report associated with the RFID reader response statistics and the RFID tag response statistics and transmit the report. For example, the report can be transmitted to another RFID reader 506 to be used to adjust time thresholds. In another example, the report can be stored in a server or database to be used by RFID readers to update time thresholds when inventorying RFID tags.

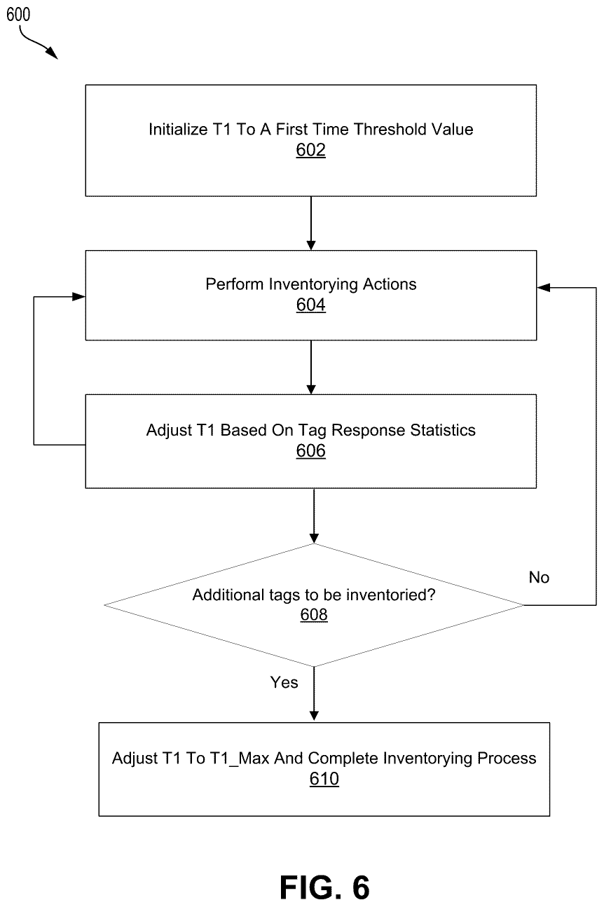

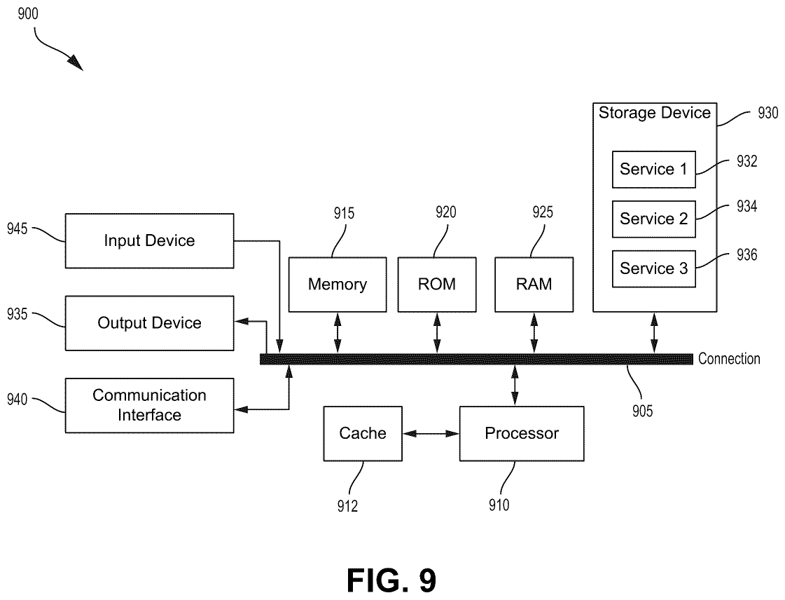

FIG. 6 is a flow diagram illustrating an example process 600 for wireless communications. In particular, the process 600 illustrates an example process of using adjustable T1 time thresholds for inventorying RFID tags, such as the RFID tag 350 of FIG. 3, the first RFID tag 410, 510 or the second RFID tag 412, 512 described in communication with the RFID reader 406, 506 in the description of FIG. 4A and FIG. 5. The process 600 can be performed by a computing device (e.g., the device 200 of FIG. 2A, the energy harvesting device 240 of FIG. 2B, the RFID reader 310 of FIG. 3, the RFID reader 406, 506 of FIG. 4A and FIG. 5, the computing device or computing system 900 of FIG. 9, etc.) or by a component or system, a chipset, one or more processors central processing units (CPUs), digital signal processors (DSPs), graphics processing units (GPUs), any other type of processor(s), any combination thereof, or other component or system) of the computing device. The operations of the process 800 can be implemented as software components that are executed and run on one or more processors (e.g., processor 210 of FIG. 2A, the energy harvesting device 240 of FIG. 2B, the processor 910 of FIG. 9, or other processor(s)) of the computing device. Further, the transmission and reception of signals by the computing device in the process 800 can be enabled, for example, by one or more antennas and/or one or more transceivers (e.g., wireless transceiver(s)).

At block 602, the computing device (or component thereof such as an RFID reader) can initialize T1 to a first time threshold value. For example, T1 can be initially set to a threshold value such as

$${T}_{1 \_ Threshold} = MAX ( RTcal , 10 {T}_{pri} ) * ( 1 + \frac{2}{3} * \vert FrT \vert ) + 2 us .$$

In comparison, T1 is generally set to MAX(RTcal, 10Tₚᵣᵢ)*(1−|FrT|)−2 us≤T₁≤MAX(RTcal, 10Tₚᵣᵢ)*(1+|FrT|)+2 us. In examples where the RFID tags have been inventoried, the computing device (or component thereof) can initially set T1 to a different threshold value such as to average time of replies within two standard deviations of a T1 from a past inventorying operation under similar conditions (e.g., temperature, manufacturer, configuration of RFID tags, etc.).

At block 604, the computing device (or component thereof such as the RFID reader) can perform inventorying actions using the T_{1_Threshold}. Further description of inventorying actions and inventorying processes is provided in the description of FIG. 4A. For example, the RFID reader can transmit a query to one or more RFID tags. The RFID reader can use the T_{1_Threshold} as a time threshold to determine whether the RFID tags respond at an appropriate rate (e.g., responding before the expiration of T_{1_Threshold}).

At block 606, the computing device (or component thereof such as the RFID reader) can adjust T1 based on RFID tag response statistics. For example, the RFID tag response statistics can be based on the response time of other RFID tags from a plurality of RFID tags to be inventoried. In further examples, the RFID tag response statistics can be associated with past inventorying actions of the RFID tags. In such an example, the RFID reader can adjust T1 based on how the RFID tags in a particular area responded in a prior inventorying process.

At block 608, the computing device (or component thereof such as the RFID reader) can determine whether additional RFID tags are to be inventoried. For example, the RFID reader can wait for no replies when a Q-value of the RFID reader equals 0. Generally, when Q-value equals 0 and no additional RFID tags reply, the computing device (or the RFID reader) can determine there are no further RFID tags to be inventoried. In such an example, because the T1 time threshold was adjusted, when the Q-value equals 0, the RFID reader can proceed to block 610 to determine to continue the inventorying process for an additional cycle with T1 set a higher value (e.g., T_{1_MAX}). When there are additional RFID tags to be inventoried (e.g., Q-value does not equal 0 or additional RFID tags reply), the process can return to block 604 to continue the inventorying process.

At block 610, the computing device (or component thereof such as the RFID reader) can adjust T1 to T_{1_MAX} to confirm whether there are additional RFID tags to inventory. In some examples, the RFID reader can maintain T1 as T_{1_MAX} to inventory remaining RFID tags. In further examples, the RFID reader can transmit a query command with a Q-value set to 0. When no RFID tags respond with T1 set to T_{1_MAX}, the computing device can determine no additional RFID tags remain to be inventoried. In further examples, the RFID reader can return to block 604 when the RFID reader detects additional RFID tags with T1 adjusted to T_{1_MAX}.

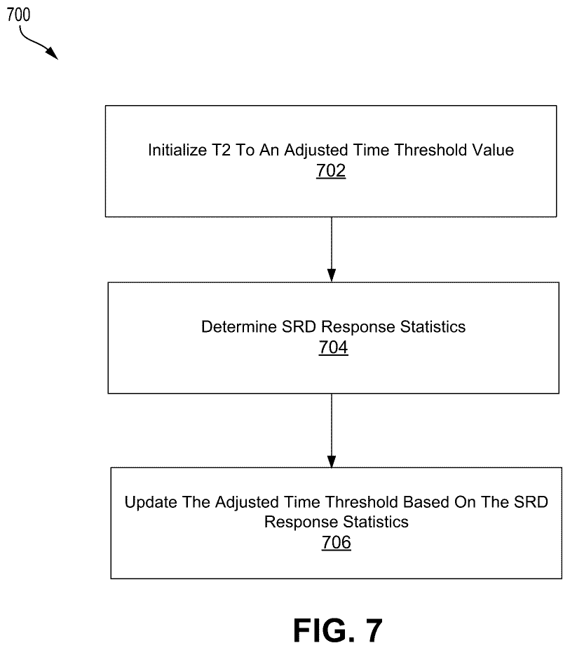

FIG. 7 is a flow diagram illustrating an example process 700 for wireless communications. In particular, the process 600 illustrates an example process of using adjustable T2 time thresholds for inventorying RFID tags, such as the RFID tag 350 of FIG. 3, the first RFID tag 410, 510 or the second RFID tag 412, 512 described in communication with the RFID reader 406, 506 in the description of FIG. 4A and FIG. 5. The process 600 can be performed by a computing device (e.g., the device 200 of FIG. 2A, the energy harvesting device 240 of FIG. 2B, the RFID reader 310 of FIG. 3, the RFID reader 406, 506 of FIG. 4A and FIG. 5, the computing device or computing system 900 of FIG. 9, etc.) or by a component or system, a chipset, one or more processors central processing units (CPUs), digital signal processors (DSPs), graphics processing units (GPUs), any other type of processor(s), any combination thereof, or other component or system) of the computing device. The operations of the process 800 can be implemented as software components that are executed and run on one or more processors (e.g., processor 210 of FIG. 2A, the energy harvesting device 240 of FIG. 2B, the processor 910 of FIG. 9, or other processor(s)) of the computing device. Further, the transmission and reception of signals by the computing device in the process 800 can be enabled, for example, by one or more antennas and/or one or more transceivers (e.g., wireless transceiver(s)).

At block 702, the computing device (or component thereof such as an SRD and/or RFID reader) can initialize T2 to an adjusted time threshold value. For example, T2 is generally set in the range of 3Tₚᵣᵢ≤T₂≤20Tₚᵣᵢ with Tₚᵣᵢ representing a backscatter-link pulse-repetition (BLF) interval (Tₚᵣᵢ=1/BLF) of the RFID reader and RFID tags. RFID tags generally wait 20Tₚᵣᵢ≤T_{2_max}≤32Tₚᵣᵢ when determining whether T2 has expired (e.g., determining whether to wait for a response from the RFID reader). The RFID reader can set T2 to a time threshold value associated with a max time RFID tags generally wait for an RFID reader response (e.g., set T2 to T_{2_Threshold}=32Tₚᵣᵢ).

At block 704, the computing device (or component thereof such as an SRD and/or an RFID reader) can determine SRD (e.g., RFID reader) response statistics associated with whether RFID tags waited for a response from the SRD (or RFID reader) before the adjusted T2 threshold (e.g., T_{2_Threshold}). For example, the SRD response statistics can represent a highest wait time of one or more RFID tags from a plurality of RFID tags to be inventoried. In such an example, a first RFID tag can wait a period of time such as until 28 Tₚᵣᵢ and a second RFID tag can wait a period of time such as until 30 Tₚᵣᵢ. In such an example, the SRD response statistics can indicate the RFID reader should respond to the RFID tag by 28 Tₚᵣᵢ to inventory the first RFID tag. In another example, computing device (or component thereof) can run logistic regression over prior reply data (e.g., reply timing information associated with RFID tags or SRD) for prior reply data with timing greater than 20 Tₚᵣᵢ. The computing device (or component thereof) can determine the T2 threshold, such as by setting the T2 threshold to 24 Tₚᵣᵢ.

At block 706, the computing device (or component thereof such as the SRD) can update the adjusted time threshold based on the SRD response statistics. For example, where the SRD determined the first RFID tag waits until 28 Tₚᵣᵢ before transitioning to an arbitrate state (also referred to as an arbitration state), the SRD can update the adjusted time threshold of T2 to 28 Tₚᵣᵢ. In such an example, T2 can be set to T_{2_Threshold}=28Tₚᵣᵢ. In further examples, the computing device (or component thereof) can adjust the time threshold based on response times of a plurality of RFID tags. For example, the computing device (or component thereof) can wait to adjust the time threshold until a predetermined number of responses have been received.

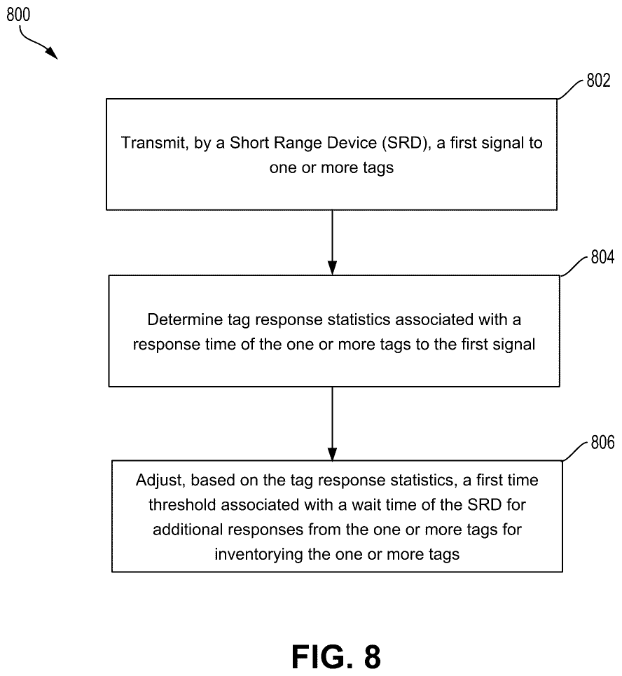

FIG. 8 is a flow diagram illustrating an example process 800 for wireless communication. In particular, the process 800 illustrates an example process of inventorying RFID tags, such as the RFID tag 350 of FIG. 3 or the RFID tags described in communication with the RFID reader 406, 506 in the description of FIG. 4A and FIG. 5. The process 800 can be performed by a computing device (e.g., the device 200 of FIG. 2A, the RFID reader 310 of FIG. 3, the RFID reader 406, 506 of FIG. 4A and FIG. 5, the computing device or computing system 900 of FIG. 9, etc.) or by a component or system, a chipset, one or more processors central processing units (CPUs), digital signal processors (DSPs), graphics processing units (GPUs), any other type of processor(s), any combination thereof, or other component or system) of the computing device. The operations of the process 800 can be implemented as software components that are executed and run on one or more processors (e.g., processor 210 of FIG. 2A, the processor 910 of FIG. 9, or other processor(s)) of the computing device. Further, the transmission and reception of signals by the computing device in the process 800 can be enabled, for example, by one or more antennas and/or one or more transceivers (e.g., wireless transceiver(s)).

At block 802, a computing device (or component thereof) can transmit, by a short range device (SRD) (such as or including a Radio Frequency Identification (RFID) reader), a first signal to one or more tags (such as or including one or more RFID tags). For example, the SRD can transmit signals to the one or more tags to inventory the one or more tags. In such an example, the first signal can be a query inventorying command, such as the Query(T) command from the description of FIG. 4A.

At block 804, the computing device (or component thereof) can determine tag response (e.g., RFID tag response) statistics associated with a response time of the one or more tags to the first signal. For example, the computing device (or component thereof) can monitor tag response times and generate a distribution (e.g., a standard normal distribution) of the tag response times. The computing device (or component thereof) can determine statistics including a standard deviation of tag response times of the distribution based on the tag response times. Further tag response statistics can include an average tag response time. In another example, the tag response statistics can include a max detected tag response time and minimum detected tag response time. In some examples, the computing device (or component thereof) can transmit (e.g., by the SRD) a second signal to the one or more tags. In some examples, the second signal is a query inventorying command, such as the Query(T) command from the description of FIG. 4A. The computing device (or component thereof) can update the tag response statistics, and the first time threshold based on the second signal. For example, the computing device (or component thereof) can update tag response statistics after each tag response. In further examples, the computing device (or component thereof) can update tag response statistics after a predetermined number of tag responses.

At block 806, the computing device (or component thereof) can adjust, based on the tag response statistics, a first time threshold associated with a wait time of the SRD for additional responses from the one or more tags for inventorying the one or more tags. In some examples, the first time threshold can be associated with a threshold T1 of the EPC Gen2 standards. In another example, the computing device (or component thereof) can transmit a report associated with the tag response statistics. For example, the report can be a text report including a distribution (e.g., a standard distribution) representation of the tag response times. In further examples, the report can include determined standard deviations based on the distribution. In another example, the report can include tag response statistics such as an average tag response time, the standard deviation of tag response times, a minimum tag response time (e.g., the fastest tag response time during inventorying), a maximum tag response time (e.g., the slowest tag response time during inventorying), etc.

In some examples, the computing device (or component thereof) can transmit the tag response statistics to a database of tag response statistics (e.g., a database of RFID tag response statistics). In such an example, the computing device (or component thereof) can query the database for tag response statistics. The computing device (or component thereof) can set an initial value of the first time threshold based on tag response statistics from the database. For example, tag response statistics can be stored based on characteristics of the tags such as manufacturer and model of the tags, manufacturer and model of the SRD (e.g., RFID reader or other type of reader), operating conditions of the tags and SRD (e.g., temperature of the tags and the SRD, ambient temperature, amount of signal interference during operation, etc.), configuration of the tags in the environment, etc. The computing device or additional computing devices can query the database based on the characteristics (e.g., query based on manufacturer, model, operating conditions, etc.) of the tags and receive tag response statistics associated with the characteristics. The computing device or additional computing devices can use the response statistics to set an initial value of the first time threshold.

In some examples, the computing device (or component thereof) can receive an tag response from the one or more tags and transmit, by the SRD (or RFID reader), a second signal to the one or more tags. In such an example, the second signal can be transmitted to the one or more tags within a second time threshold associated with an SRD (e.g., RFID reader) response to the tag response. In some examples, the second signal can include the SRD response. In such an example, the SRD response can be an acknowledgement (ACK) message, such as one of the ACK messages of FIG. 4A.

In further examples, the computing device (or component thereof) can determine SRD response statistics associated with a time period in which the one or more tags wait for the SRD response before transitioning to an arbitrate state. In some examples, the computing device (or component thereof) can use logistic regression techniques to determine a logistic regression cutoff threshold from the turnaround time beyond 20 Tₚᵣᵢ. In some examples, the computing device can use machine learning algorithms for binary classifications based on SRD response times to determine the logistic regression cutoff threshold (e.g., binary such as having two classifications: classify response and no response). In other examples, the SRD response statistics can include statistics such as an average SRD response time, a standard deviation of SRD response times, a minimum SRD response time (e.g., the fastest SRD response time during inventorying), a maximum SRD response time (e.g., the slowest SRD response time during inventorying), etc. In some examples, the computing device (or component thereof) can adjust (e.g., increase or decrease) the second time threshold based on the SRD response statistics.

In some examples, the computing device (or component thereof) can receive a subsequent tag response (e.g., a subsequent RFID tag response) from the one or more tags and transmit, by the SRD, a third signal to the one or more tags. In such an example, the third signal can be transmitted to the one or more tags within the adjusted second time threshold associated with the SRD response to the tag response. For example, the second time threshold can be associated with T2 of the EPC Gen2 standards. In some examples, the subsequent tag response can be an RN16 response, EPC response, or other inventorying response, as further described in the description of tag responses in FIG. 4A. The computing device (or component thereof) can update the SRD response statistics, and the second time threshold based on the subsequent tag response.

In another example, the computing device (or component thereof) can transmit a report associated with the SRD response statistics. For example, the report can be a text report including the SRD response statistics. In some examples, the computing device (or component thereof) can transmit the SRD response statistics to a database of SRD response statistics. In such an example, the computing device (or component thereof) can query the database for SRD response statistics. In such an example, the computing device (or component thereof) can set an initial value of the second time threshold based on SRD response statistics from the database. In further examples, additional computing devices can receive SRD response statistics from the database to set an initial values of time thresholds (e.g., a time threshold associated with T2 of the EPC GEN 2 standards) for inventorying tags (e.g., RFID tags or other types of tags).

FIG. 9 is a diagram illustrating an example of a system for implementing certain aspects of the present technology. In particular, FIG. 9 illustrates an example of computing system 900, which can be for example any computing device making up internal computing system, a remote computing system, a camera, or any component thereof in which the components of the system are in communication with each other using connection 905. Connection 905 can be a physical connection using a bus, or a direct connection into processor 910, such as in a chipset architecture. Connection 905 can also be a virtual connection, networked connection, or logical connection.

In some aspects, computing system 900 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 900 includes at least one processing unit (CPU or processor) 910 and connection 905 that couples various system components including system memory 915, such as read-only memory (ROM) 920 and random access memory (RAM) 925 to processor 910. Computing system 900 can include a cache 912 of high-speed memory connected directly with, in close proximity to, or integrated as part of processor 910.

Processor 910 can include any general purpose processor and a hardware service or software service, such as services 932, 934, and 936 stored in storage device 930, configured to control processor 910 as well as a special-purpose processor where software instructions are incorporated into the actual processor design. Processor 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms. In some instances, multimodal systems can enable a user to provide multiple types of input/output to communicate with computing system 900. Computing system 900 can include communications interface 940, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 930 can include software services, servers, services, etc., that when the code that defines such software is executed by the processor 910, it causes the system to perform a function. In some aspects, a hardware service that performs a particular function can include the software component stored in a computer-readable medium in connection with the necessary hardware components, such as processor 910, connection 905, output device 935, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, an engine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the present disclosure include:

Aspect 1. An apparatus for wireless communication, the apparatus comprising: at least one memory; and at least one processor coupled to the at least one memory and configured to: transmit, by a short range device (SRD), a first signal to one or more tags; determine tag response statistics associated with a response time of the one or more tags to the first signal; and adjust, based on the tag response statistics, a first time threshold associated with a wait time of the SRD for additional responses from the one or more tags for inventorying the one or more tags.

Aspect 2. The apparatus of Aspect 1, wherein the first signal is a query inventorying command.

Aspect 3. The apparatus of any of Aspects 1 to 2, wherein the tag response statistics includes data associated with an average response time and a standard deviation of response times of the one or more tags.

Aspect 4. The apparatus of any of Aspects 1 to 3, wherein the at least one processor is configured to: transmit, by the SRD, a second signal to the one or more tags; and update the tag response statistics and the first time threshold based on the second signal.

Aspect 5. The apparatus of any of Aspects 1 to 4, wherein the second signal is a query inventorying command.

Aspect 6. The apparatus of any of Aspects 1 to 5, wherein the at least one processor is configured to: transmit a report associated with the tag response statistics.

Aspect 7. The apparatus of any of Aspects 1 to 6, wherein the at least one processor is configured to: receive an tag response from the one or more tags; transmit, by the SRD, a second signal to the one or more tags, wherein the second signal is transmitted to the one or more tags within a second time threshold associated with an SRD response to the tag response and the second signal includes the SRD response; determine SRD response statistics associated with a time period in which the one or more RFID tags wait for the SRD response before transitioning to an arbitrate state; and adjust the second time threshold based on the SRD response statistics.

Aspect 8. The apparatus of any of Aspects 1 to 7, wherein the second signal is an acknowledgement (ACK) message.

Aspect 9. The apparatus of any of Aspects 1 to 8, wherein the at least one processor is configured to: receive a subsequent tag response from the one or more tags; transmit, by the SRD, a third signal to the one or more tags, wherein the third signal is transmitted to the one or more tags within the adjusted second time threshold associated with the SRD response to the tag response; and update the SRD response statistics and the second time threshold based on the subsequent tag response.

Aspect 10. The apparatus of any of Aspects 1 to 9, wherein the at least one processor is configured to: transmit a report associated with the SRD response statistics.

Aspect 11. The apparatus of any of Aspects 1 to 10, wherein the SRD is a Radio Frequency Identification (RFID) reader, and wherein the one or more tags include one or more RFID tags.

Aspect 12. A method for wireless communication, the method comprising: transmitting, by a short range device (SRD), a first signal to one or more tags; determining tag response statistics associated with a response time of the one or more tags to the first signal; and adjusting, based on the RFID tag response statistics, a first time threshold associated with a wait time of the SRD for additional responses from the one or more tags for inventorying the one or more tags.

Aspect 13. The method of Aspect 12, wherein the first signal is a query inventorying command.

Aspect 14. The method of any of Aspects 12 to 13, wherein the tag response statistics includes data associated with an average response time and a standard deviation of response times of the one or more tags.

Aspect 15. The method of any of Aspects 12 to 14, further comprising: transmitting, by the SRD, a second signal to the one or more tags; and updating the tag response statistics and the first time threshold based on the second signal.

Aspect 16. The method of any of Aspects 12 to 15, wherein the second signal is a query inventorying command.

Aspect 17. The method of any of Aspects 12 to 16, further comprising: transmitting a report associated with the tag response statistics.

Aspect 18. The method of any of Aspects 12 to 17, further comprising: receiving an tag response from the one or more tags; transmitting, by the SRD, a second signal to the one or more tags, wherein the second signal is transmitted to the one or more tags within a second time threshold associated with an SRD response to the tag response and the second signal includes the SRD response; determining SRD response statistics associated with a time period in which the one or more tags wait for the SRD response before transitioning to an arbitrate state; and adjusting the second time threshold based on the SRD response statistics.

Aspect 19. The method of any of Aspects 12 to 18, wherein the second signal is an acknowledgement (ACK) message.

Aspect 20. The method of any of Aspects 12 to 19, further comprising: receiving a subsequent tag response from the one or more tags; transmitting, by the SRD, a third signal to the one or more tags, wherein the third signal is transmitted to the one or more tags within the adjusted second time threshold associated with the SRD response to the tag response; and updating the SRD response statistics and the second time threshold based on the subsequent tag response.

Aspect 21. The method of any of Aspects 12 to 20, further comprising: transmitting a report associated with the SRD response statistics.

Aspect 22. The method of any of Aspects 12 to 21, wherein the SRD is a Radio Frequency Identification (RFID) reader, and wherein the one or more tags include one or more RFID tags.

Aspect 23. A non-transitory computer-readable medium having stored thereon instructions that, when executed by at least one processor, cause the at least one processor to perform one or more of operations according to any of Aspects 12 to 22.

Aspect 24. An apparatus for wireless communication, the apparatus comprising one or more means for performing operations according to any of Aspects 12 to 22.

1. An apparatus for wireless communication, the apparatus comprising:
at least one memory; and
at least one processor coupled the at least one memory and configured to:
transmit, by a short range device (SRD), a first signal to a plurality of tags;
determine tag response statistics associated with a response time for the plurality of tags to respond to the first signal; and
adjust, based on the tag response statistics, a first time threshold associated with a wait time of the SRD for additional responses from the plurality of tags for inventorying the plurality of tags.

2. The apparatus of claim 1, wherein the first signal is a query inventorying command.

3. The apparatus of claim 1, wherein the tag response statistics includes data associated with an average response time and a standard deviation of response times of the plurality of tags.

4. The apparatus of claim 1, wherein the at least one processor is configured to:
transmit, by the SRD, a second signal to the plurality of tags; and
update the tag response statistics and the first time threshold based on the second signal.

5. The apparatus of claim 4, wherein the second signal is a query inventorying command.

6. The apparatus of claim 1, wherein the at least one processor is configured to:
transmit a report associated with the tag response statistics.

7. The apparatus of claim 1, wherein the at least one processor is configured to:
receive a tag response from the plurality of tags;
transmit, by the SRD, a second signal to the plurality of tags, wherein the second signal is transmitted to the plurality of tags within a second time threshold associated with an SRD response to the tag response and the second signal includes the SRD response;
determine SRD response statistics associated with a time period in which the plurality of tags wait for the SRD response before transitioning to an arbitrate state; and
adjust the second time threshold based on the SRD response statistics.

8. The apparatus of claim 7, wherein the second signal is an acknowledgement (ACK) message.

9. The apparatus of claim 7, wherein the at least one processor is configured to:
receive a subsequent tag response from the plurality of tags;
transmit, by the SRD, a third signal to the plurality of tags, wherein the third signal is transmitted to the plurality of tags within the adjusted second time threshold associated with the SRD response to the tag response; and
update the SRD response statistics and the second time threshold based on the subsequent tag response.

10. The apparatus of claim 9, wherein the at least one processor is configured to:
transmit a report associated with the SRD response statistics.

11. The apparatus of claim 1, wherein the SRD is a Radio Frequency Identification (RFID) reader, and wherein the plurality of tags include a plurality of RFID tags.

12. A method for wireless communication, the method comprising:
transmitting, by a short range device (SRD), a first signal to a plurality of tags;
determining tag response statistics associated with a response time for the plurality of tags to respond to the first signal; and
adjusting, based on the tag response statistics, a first time threshold associated with a wait time of the SRD for additional responses from the plurality of tags for inventorying the plurality of tags.

13. The method of claim 12, wherein the first signal is a query inventorying command.

14. The method of claim 12, wherein the tag response statistics includes data associated with an average response time and a standard deviation of response times of the plurality of tags.

15. The method of claim 12, further comprising:
transmitting, by the SRD, a second signal to the plurality of tags; and
updating the tag response statistics and the first time threshold based on the second signal.

16. The method of claim 15, wherein the second signal is a query inventorying command.

17. The method of claim 12, further comprising:
transmitting a report associated with the tag response statistics.

18. The method of claim 12, further comprising:
receiving a tag response from the plurality of tags;
transmitting, by the SRD, a second signal to the plurality of tags, wherein the second signal is transmitted to the plurality of tags within a second time threshold associated with an SRD response to the tag response and the second signal includes the SRD response;
determining SRD response statistics associated with a time period in which the plurality of tags wait for the SRD response before transitioning to an arbitrate state; and
adjusting the second time threshold based on the SRD response statistics.

19. The method of claim 18, wherein the second signal is an acknowledgement (ACK) message.

20. The method of claim 18, further comprising:
receiving a subsequent tag response from the plurality of tags;
transmitting, by the SRD, a third signal to the plurality of tags, wherein the third signal is transmitted to the plurality of tags within the adjusted second time threshold associated with the SRD response to the tag response; and
updating the SRD response statistics and the second time threshold based on the subsequent tag response.
